(19) United States
(12) Patent Application Publication
(10) Pub. No.: US 2010/0131416 A1
(43) Pub. Date: May 27, 2010

(54) Building Pin Identification System

(76) Inventor: Daryl Anne Means, Tallahassee, FL (US)

Correspondence Address: Daryl Means, 5725 Roanoke Trail, Tallahassee, FL, 32312, US

(21) Appl. No.: 12/186,796

(22) Filed: Nov. 25, 2008

(51) Int. Cl. G06Q 99/00

(52) U.S. Cl. 705/300; 705/7; 705/313

(57) ABSTRACT

This utility non-provisional patent is being applied for a building and property numbering identification software system. This system will be designed to function to provide all agencies, companies and public usage to access up to date information on all structures and properties. This will include everything from land size and conditions to building types, mechanical, electrical, plumbing, fire codes, life safety, handicap compliances, building materials, etc. There will be a central data base where all information may be accessed via an access fee. This information will be particularly valuable but not limited to, insurance companies, banking and finance, underwriters, county/city code enforcers, field inspectors, realtors and general public consumers. With this information available it will save time and money for both public and private usage to make informed decisions regarding property compliance and value.

This non-provisional patent application is being applied for an Identification Numbering System to develop a software system that would use a central data base created to maintain information records on all properties. This system would assign an identification number that would be unique to each property. This identification number would remain as the primary and only identification number for the purpose of collecting and maintaining an accurate information data base as to the structure, land, manufacturers, building code compliance, and various other details pertaining to the structure and all related products and issues. This system would be designed to perform as a software system that would provide information to bridge all individuals and companies needing to access this valuable information. This information would further protect and inform the public and businesses at large such as applicable property information for consumer purchasing, insurance underwriting, and title company abstract research for property transactions, banking and lending institutions for loan underwriting. This would include but not be limited to include; single family, multi family, (single family homes, apartments, duplexes, townhouses dwellings) and commercial structures. The concept for the identification systems is that all structures would be issued an identification number at the time that the structure is built, sold or transferred ownership.

There would also be an opportunity to log into the system to submit your information to be included in the data base. When an identification number is being assigned to an existing structure, then the number would be recorded at the time the property transfers ownership. Information would continually be updated within the data base to include but not limited to: homeowner inspection report findings, repairs and maintenance performed on structure or property, commercial building inspection reports, flood occurrences or changes, acts of god, local and state code compliances, additions and all renovations. The complete history of the construction and activity involving the property would contain but not be limited to:

Property: Lot size, location, flood areas, lakes, rives, oceans, springs, (with distance to water areas) hurricane areas, earthquake conditions, slope of land, ground conditions, sink holes and soil conditions.

Legal Information: Current owners and previous owners, home associations, home association fees, city/county development fees, recorded information, survey information, building code information (year built) flood zones, hurricane zone.

Construction: Type of structure, type of windows, roofing type and material, and wind load home was built to and what year constructed, appliances type, model and energy rating, electrical type and amps/loads, generator system load capacity, mechanical system type and energy level, plumbing fixtures and type, insulation type rating and location, floor covering, driveway material an thickness, landscape and irrigation, outside structures, swimming pools, outer buildings, all products to have manufacturers, model name and numbers.

Construction Repairs: This would identify and track all repairs, replacement and updates that would be done to any of the type of dwellings or structures. This would relate to all conditions either interior or exterior of structure and areas within the property boundaries.

Construction Additions: This would include all additions and enhancements to the structure. All materials, model numbers and manufactures would be listed as per the original structure and will include all updated and replace systems to date.

Identification Number: This number would be assigned by the software program and would remain as the permanent identification number for the property as long as the property existed. This number would not change and all information regarding the property would be applied under that number to the data base. This system would allow for any person or company to access this information to give them an up to date property information.

Exterior Structures: This would pertain to any and all structures within the property boundaries. This would include but be limited to swimming pools, tennis courts, stables, barns, pool houses, garages, pump houses, and green houses.

Closing: This utility patent would revolutionize the building industry and how companies and people handle the transaction of buying and selling properties. It will further help banks, insurance companies and all underwriting agencies to make informed decisions that will result in cost savings to the industry at large. This would protect the businesses providing the services and the public who may be purchasing these services. Finally since choices will be based on accurate information updated on a regular basis it will save money to both business and the public.

1. This non-provisional patent application is being applied for an Identification Numbering System to develop a software system that would use a central data base created to maintain information records on all properties.
This system would assign an identification number that would be unique to each property.
This identification number would remain as the primary and only identification number for the purpose of collecting and maintaining an accurate information data base as to the structure, land manufacturer, building code compliance, and various other details pertaining to the structure and all related products and issues.
This system would be designed to perform as a software system that would provide information to bridge all individuals and companies needing to access this valuable information.
This information would further protect and inform the public and businesses at large for information needed such as applicable property information for consumer purchasing, insurance underwriting, banking and title company abstract research for property transactions, banking and lending institutions for loan underwriting and many other associated tasks.
This would include all properties new and exiting, raw land, commerical structures and many others.
There would also be an opportunity to log into the system to submit your information to be included in the data base. When an identification number is being assigned to an existing structure, then the number would be recorded at the time the property transfers ownership.
Information would continually be updated within the data base to include but not limited to: homeowner inspection report findings, repairs and maintenance performed on structure or property, commercial building inspection reports, flood occurrences, fires, acts of god, local and state code compliances, additions and all renovations and improvements or corrections.
The complete history of the construction and activity involving the property would contain all historical data and not be limited.
